(19) United States
(12) Patent Application Publication
(10) Pub. No.: US 2012/0244804 A1
(43) Pub. Date: Sep. 27, 2012

(54) COMMUNICATION DEVICE AND ELECTRONIC EQUIPMENT

(75) Inventor: Norio MASUDA, Tokyo (JP)

(73) Assignee: NETCOMSEC CO., Ltd., Tokyo (JP)

(21) Appl. No.: 13/421,767

(22) Filed: Mar. 15, 2012

(30) Foreign Application Priority Data
Mar. 23, 2011 (JP) 2011-064167

(51) Int. Cl. H04B 5/00

(52) U.S. Cl. 455/41.1

(57) ABSTRACT

A communication device comprises: a first transmitting and receiving element that generates and detects a magnetic field; and a second transmitting and receiving element that detects a magnetic field generated by the first transmitting and receiving element and generates a magnetic field detectable by the first transmitting and receiving element. The first and second transmitting and receiving elements transmit and receive signals through magnetic field coupling between ends of the first element second transmitting and receiving elements.

This application is based upon and claims the benefit of priority from Japanese patent application No. 2011-064167, filed on Mar. 23, 2011, the disclosure of which is incorporated herein in its entirety by reference.

### TECHNICAL FIELD

The present invention relates to a communication device for transmitting and receiving signals using magnetic field coupling type transmitting and receiving elements and to electronic equipment including the communication device.

### BACKGROUND ART

Relatively large electronic equipment may include a module for each function. In such electronic equipment comprising a plurality of modules, usually, the modules are connected with each other via connectors and cables. For electronic equipment installed outdoors, such as telecommunication equipment used for satellite communications, the connectors and cables through which the modules are connected with each other need to be made waterproof. Because waterproof connectors include sealing gaskets and the like, most of such connectors are large. In addition, for electronic equipment installed outdoors, connectors and cables may need to be protected from falling objects and the like by covering the connectors and cables. As a result, since electronic equipment installed outdoors includes large connectors and covers, the housing of each module tends to be large. Therefore, in order to make such the housing small, the number of connectors and cables needs to be reduced.

As a way to solve such a problem, instead of wiring connections via connectors and cables, wireless technology may be adopted to connect modules with each other. Known examples of such technology include a contactless connector scheme in which signals are transmitted without contact by using a magnetic field.

However, if the electronic equipment installed outdoors comprises a metal housing, contactless connectors that use a magnetic field cannot transfer, through a wall of the housing made of metal, magnetic flux sufficient to transmit signals because the wall interrupts the magnetic field. For this reason, it is necessary to make a hole through the housing or to expose transmitting and receiving elements and make them close to each other. As a result, even in the case of contactless connector schemes, like the above-described connectors through which contacts are mechanically brought into contact with each other, waterproof and protection measures are needed.

To address the problem, for example, Japanese Patent Laid-Open No. 2005-20364 has proposed a technique that enables electromagnetic communications without interruptions caused by a metal cover. The technique described in Japanese Patent Laid-Open No. 2005-20364 enables electromagnetic communications by making the metal layer thin enough to allow electromagnetic communications through electromagnetic induction without losing mechanical protection performance.

However, in relatively large electronic equipment such as telecommunication equipment used for satellite communications, it is necessary to use a metal plate having a thickness of about several millimeters to several centimeters as a housing to ensure adequate strength. For this reason, it is difficult to form housing a thin metal plate like the technique described in Japanese Patent Laid-Open No. 2005-20364. Moreover, if a thick metal plate is adopted, the loss caused by eddy currents generated by the application of a magnetic field becomes considerable, and the distance between transmitting and receiving elements is also relatively increased. Consequently, the amount of current used to generate a magnetic field needed for signal transmission becomes larger, resulting in an increase in the power consumption of the electronic equipment.

Further, consideration is given to using near field communication such as a wireless tag that transmits and receives signals by radio waves for contactless communications between modules. However, because such near field communication requires an antenna for wireless communications to be installed on the outside of the housing, the housing of each module becomes large. Furthermore, in signal transmission by radio waves, because the communication environment may be deteriorated by electromagnetic interference, signals are unfortunately erroneously transmitted and the transmission rate is lowered. Thus, measures against these problems are needed (enhancing error correction, preventing transmission rate from lowering, and the like), resulting in complicated processing to transmit and receive signals. In addition, disadvantageously, transmission efficiency declines.

As described above, in the electronic equipment installed outdoors, a method for transmitting electrical signals needs to be improved in order to reduce the size of the housing. In particular, a method is useful that enables contactless communications and communications with the outside of the housing even if a transmitting and receiving element is installed in the housing. If a transmitting and receiving element can be installed in the housing, the waterproof and protection measures for the transmitting and receiving element may be reduced or eliminated. In addition, electromagnetic interference from external electronic equipment can be reduced. Further, a relatively large connector and cover do not need to be installed on the external wall of housing. As well, if a transmitting and receiving element is installed in an empty space in the housing, the size of the housing can be reduced.

### SUMMARY

An object of the present invention is to provide a communication device for enabling contactless signal transmission between housings and electronic equipment including the communication device.

To achieve the object, a communication device according to an exemplary aspect of the present invention comprises: a first transmitting and receiving element that generates and detects a magnetic field; and a second transmitting and receiving element that detects a magnetic field generated by the first transmitting and receiving element and generates a magnetic field detectable by the first transmitting and receiving element. The first and second transmitting and receiving elements transmit and receive a signal through magnetic field coupling between ends of the first and second transmitting and receiving elements.

On the other hand, electronic equipment according to an exemplary aspect of the present invention comprises: a first module including the first transmitting and receiving element installed in the inner wall of housing made of a metal plate; and a second module including the second transmitting and receiving element installed in the inner wall of housing made of a metal plate so as to face the first transmitting and receiving element.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a block diagram illustrating an exemplary configuration of electronic equipment including a communication device of the present invention;

FIG. 2 is a schematic diagram illustrating an exemplary configuration of a communication device according to a first exemplary embodiment;

FIG. 3 is a schematic diagram illustrating an exemplary configuration of a communication device according to a second exemplary embodiment;

FIG. 4 is a schematic diagram illustrating a modified example of the communication device according to the second exemplary embodiment;

FIG. 5 is a schematic diagram illustrating an exemplary configuration of a communication device according to a third exemplary embodiment;

FIG. 6 is a schematic diagram illustrating an exemplary configuration of a communication device according to a fourth exemplary embodiment;

FIG. 7A is an enlarged plan view showing a flux concentrator seen in FIG. 6;

FIG. 7B is a plan view showing how electric current flows through the flux concentrator seen in FIG. 6;

FIG. 7C is a graph showing exemplary distributions of magnetic fields generated by electric currents flowing through the flux concentrator seen in FIG. 7B;

FIG. 8A is a plan view showing a modified example of the flux concentrator seen in FIG. 7A;

FIG. 8B is a plan view showing another modified example of the flux concentrator seen in FIG. 7A; and

FIG. 9 is a schematic diagram illustrating an exemplary configuration of a communication device according to a fifth exemplary embodiment.

### EXEMPLARY EMBODIMENTS

Next, the present invention will be described with reference to the drawings.

### First Exemplary Embodiment

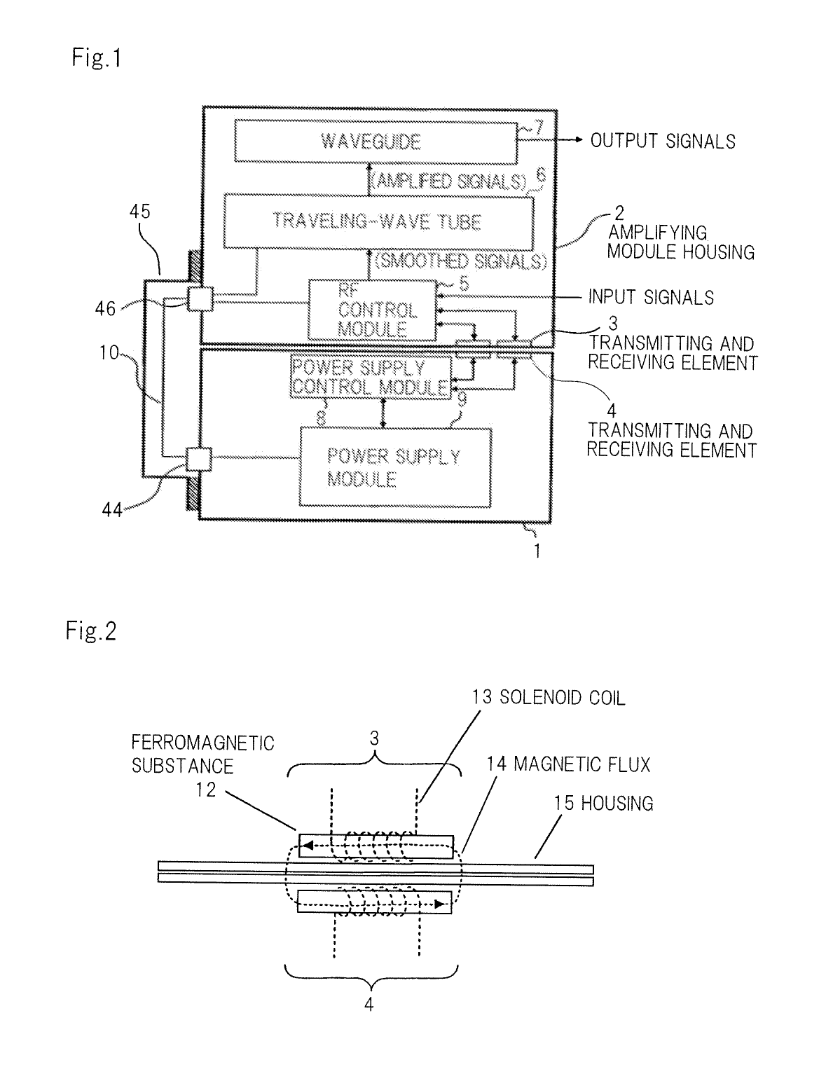

FIG. 1 is a block diagram illustrating an exemplary configuration of electronic equipment including a communication device of the present invention. FIG. 1 illustrates an exemplary configuration of a microwave power module (MPM) installed outdoors and used for satellite communications or the like.

As illustrated in FIG. 1, the microwave power module includes power supply module housing 1 and amplifying module housing 2, and power supply module housing 1 and amplifying module housing 2 are connected with each other. The microwave power module as illustrated in FIG. 1 is mainly used to amplify high frequency signals within a quasi-microwave band to a submillimeter band. Such electronic equipment may be positioned as an infrastructure, so that in the event of failure, quick repair is required. In the configuration illustrated in FIG. 1, quick repair can be achieved by replacing power supply module housing 1 or amplifying module housing 2 in which a failure has occurred. Such quickness is critical in the case of an emergency, in particular, when damage is caused by a major natural disaster.

Amplifying module housing 2 includes RF control module 5, traveling-wave tube 6, and waveguide 7. Amplifying module housing 2 amplifies high frequency signals input from the outside (input signals) up to high frequency signals of high electric power of, for example, about 100 watts to 1 kilowatt, and outputs the resultant signals.

RF control module 5 smoothes out phase and amplitude characteristics of input signals and outputs the resultant signals to traveling-wave tube 6. RF control module 5 also monitors high frequency signals output from amplifying module housing 2.

Traveling-wave tube 6 amplifies high frequency signals supplied from RF control module 5 up to the required power. The high frequency signals amplified by traveling-wave tube 6 are output to the outside via waveguide 7.

Power supply module housing 1 includes power supply control module 8 and power supply module 9, and supplies amplifying module housing 2 with required power.

Power supply module 9 is supplied with power (AC or DC) from the outside via a connector and a cable not shown and generates predetermined direct-current voltage. Then, power supply module 9 supplies the generated voltage to traveling-wave tube 6 and RF control module 5 included in amplifying module housing 2.

Power supply control module 8 controls the value of voltage supplied from power supply module 9 to amplifying module housing 2 and also controls the supply itself and stopping the supply.

Power supply module housing 1 is connected with amplifying module housing 2 via connector 44, power supply cable 10, and connector 46. Connector 44, power supply cable 10, and connector 46 are mainly used to supply power-supply voltage from power supply module 9 to amplifying module housing 2. Waterproof and protecting cover 45, for example, is attached to connectors 44 and 46, and power supply cable 10, which connects power supply module housing 1 with amplifying module housing 2.

Also, as illustrated in FIG. 1, transmitting and receiving elements 3 and 4 for transmitting signals in a contactless manner are installed on the inner walls of power supply module housing 1 and amplifying module housing 2, respectively so as to face each other across these walls. Transmitting and receiving elements 3 and 4 are magnetic field coupling type elements that provide signal transmission by one transmitting and receiving element detecting a magnetic field generated by the other transmitting and receiving element. FIG. 1 illustrates an example including two transmitting and receiving elements 3 and two transmitting and receiving elements 4, whereby two signal transmission routes are provided. The number of transmission routes is not limited to two, and may be one or three or more.

Since transmitting and receiving element 3 is connected with RF control module 5 and transmitting and receiving element 4 is connected with power supply control module 8, RF control module 5 and power supply control module 8 can transmit and receive signals to and from each other via transmitting and receiving elements 3 and 4.

RF control module 5 monitors, for example, the operation state of traveling-wave tube 6 (voltage, electric current, temperature, etc.) and the quality of signals amplified by traveling-wave tube 6 (output power, a phase, etc.), and notifies power supply control module 8 of the result of the monitoring via transmitting and receiving elements 3 and 4.

Power supply control module 8 controls RF control module 5 and power supply module 9 based on the monitoring result from RF control module 5 to, for example, adjust the phase and amplitude of input signals and change start-stop sequences of traveling-wave tube 6.

FIG. 2 is a schematic diagram illustrating an exemplary configuration of a communication device according to the first exemplary embodiment.

As illustrated in FIG. 2, in the communication device of the first exemplary embodiment, transmitting and receiving elements 3 and 4 are positioned to face each other across housings 15 made of metal plates. Transmitting and receiving elements 3 and 4 include solenoid coils 13 and ferromagnetic substances 12 wound with solenoid coils 13, for example. In such a configuration, when signal currents run through solenoid coil 13, a magnetic field (magnetic flux) corresponding to the signal currents is generated. Meanwhile, when a magnetic field is generated by the opposite transmitting and receiving element, electromagnetic induction passes induced currents corresponding to the magnetic field through solenoid coil 13. As a result, transmitting and receiving elements 3 and 4 operate as communication devices that transmit and receive signals to and from each other.

Housing 15 is usually made of a paramagnetic substance such as aluminum to achieve light weight. Thus, for example, magnetic flux 14 that is generated by transmitting and receiving element 3 is emitted from one end of ferromagnetic substance 12 of element 3, penetrates housings 15, and enters one end of ferromagnetic substance 12 of transmitting and receiving element 4. The magnetic flux which enters the one end of ferromagnetic substance 12 of transmitting and receiving element 4 is emitted from the other end, penetrates housings 15, and enters the other end of ferromagnetic substance 12 of transmitting and receiving element 3. A magnetic flux generated by transmitting and receiving element 4 also travels in the same manner. That is, as illustrated in FIG. 2, transmitting and receiving elements 3 and 4 are arranged to face each other, thereby allowing magnetic field coupling of two transmitting and receiving elements 3 and 4 to be efficiently carried out. In FIG. 2, in order to couple magnetic fields to each other at the ends of ferromagnetic substances 12, ferromagnetic substances 12 of transmitting and receiving elements 3 and 4 are arranged parallel to each other. Further, arrows in FIG. 2 show how a line of magnetic flux passes through transmitting and receiving elements 3 and 4.

Transmitting and receiving elements 3 and 4 may be installed on amplifying module housing 2 and power supply module housing 1 illustrated in FIG. 1, respectively to face each other when these housings are coupled with each other in a predetermined position.

Transmitting and receiving elements 3 and 4 that are illustrated in FIG. 2 do not need to be extended from power supply module housing 1 and amplifying module housing 2 to the outside, so that taking measures to protect against failure is unnecessary. In particular, if transmitting and receiving elements 3 and 4 illustrated in FIG. 2 are used for electronic equipment installed outdoors, taking waterproof measures for connectors also becomes unnecessary.

Therefore, according to the present exemplary embodiment, there is provided a communication device that is useful for contactless signal transmission between housings.

It should be noted that in the example in FIG. 2, housings 15 are apart from each other (there is a gap therebetween), but housings 15 may be in contact with each other. Further, in the configuration example illustrated in FIG. 2, each of transmitting and receiving elements 3 and 4 is solenoid coil 13 with ferromagnetic substance 12, but as transmitting and receiving elements 3 and 4, elements other than solenoid coil 13 may be used as long as the elements can generate magnetic fields according to signal currents and detect generated magnetic fields. If an element that can detect a magnetic field with high sensitivity is used, the electric power required to generate a magnetic field can be reduced. For example, if signals are transmitted in one direction, an element that generates a magnetic field according to signal currents may be used as one transmitting and receiving element, and an element that detects a magnetic field may be used as the other transmitting and receiving element. Examples elements that detect a magnetic field include a loop element, an element using a giant magneto-resistance effect, and an element using a magnetic impedance effect.

In addition, in the example illustrated in FIG. 1, signals are transmitted and received between power supply module housing 1 and amplifying module housing 2, separate from each other, by using transmitting and receiving elements 3 and 4 illustrated in FIG. 2, but transmitting and receiving elements 3 and 4 illustrated in FIG. 2 may be applied to the case where, for example, in a housing, signals are transmitted and received between the inside and the outside of the portion separated by a metal plate. For example, it can be considered that signals are transmitted and received between a circuit covered with an electromagnetic shielding case and a circuit outside the case. Generally, it is desirable not to make a hole in electromagnetic shielding cases in order to maintain shielding properties. If transmitting and receiving elements 3 and 4 of the present exemplary embodiment are used for communications with signals between a circuit covered with an electromagnetic shielding case and a circuit outside the case, holes can be eliminated (or reduced).

### Second Exemplary Embodiment

In transmitting and receiving elements 3 and 4 of the first exemplary embodiment, since ferromagnetic substance 12 has a stick shape (see FIG. 2), magnetic flux that is generated by one transmitting and receiving element diffuses from an end of ferromagnetic substance 12, so that a part of the magnetic flux does not enter the opposite transmitting and receiving element. The magnetic flux which does not enter the other transmitting and receiving element is not used for signal transmission, leading to the loss of power required for the signal transmission. A second exemplary embodiment shows an exemplary configuration of transmitting and receiving elements for reducing such loss.

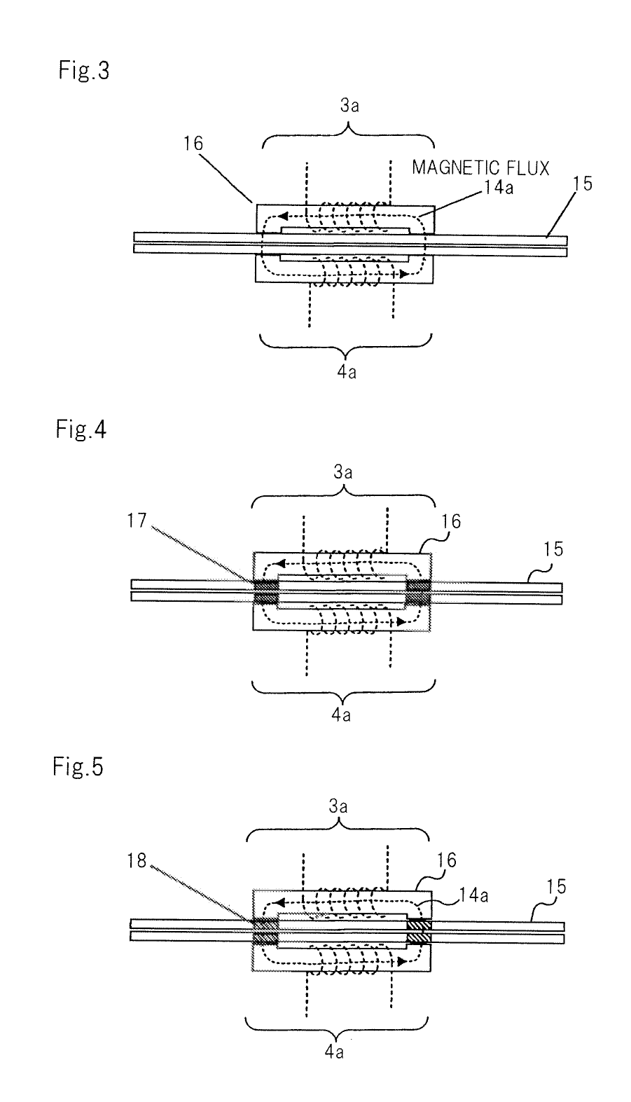

FIG. 3 is a schematic diagram illustrating an exemplary configuration of a communication device according to the second exemplary embodiment.

As illustrated in FIG. 3, in the communication device of the second exemplary embodiment, ferromagnetic substances 16 of transmitting and receiving elements 3a and 4a are substantially U-shaped, and the ends of ferromagnetic substance 16 included in transmitting and receiving element 3a and the ends of ferromagnetic substance 16 included in transmitting and receiving element 4a face each other.

In such a configuration, magnetic flux 14a generated by one transmitting and receiving element is guided according to the shape of ferromagnetic substance 16, and emitted from an end of ferromagnetic substance 16 to an end of ferromagnetic substance 16 of the other transmitting and receiving element. In addition, the distance between the ends of ferromagnetic substances 16 is shortened, so that the amount of magnetic flux that does not enter the receiving side from the transmitting side is reduced. As a result, the loss of power required for signal transmission is reduced and transmission efficiency can be improved.

In the configuration with solenoid coils and ferromagnetic substances 16 used as transmitting and receiving elements, magnetic field coupling occurs between the two transmitting and receiving elements mainly at both ends of ferromagnetic substances 16. Thus, the flow of magnetic flux can be controlled by creating the shape of ferromagnetic substance 16 as in the present exemplary embodiment, and the amount of magnetic flux that is not used for signal transmission can be reduced.

FIG. 4 is a schematic diagram illustrating a modified example of the communication device according to the second exemplary embodiment. FIG. 4 illustrates an arrangement in which non-magnetic substances 17 such as resin are embedded between the ends of ferromagnetic substance 16 included in transmitting and receiving element 3a and the ends of ferromagnetic substance 16 included in transmitting and receiving element 4a, illustrated in FIG. 3.

It is generally known that non-magnetic substances 17 such as resin less reduce the strength of entering magnetic flux. Thus, as illustrated in FIG. 4, if portions of housings 15 that are sandwiched by the ends of ferromagnetic substances 16 of the transmitting and receiving elements are replaced with non-magnetic substances 17 such as resin, the loss that occurs when magnetic flux enters housing 15 can be reduced, and bonding strength provided by the magnetic field between transmitting and receiving elements 3a and 4a can be increased.

According to the second exemplary embodiment, the amount of magnetic flux that is not used for signal transmission can be reduced more than in the communication device of the first exemplary embodiment, so that the transmission efficiency can be improved.

### Third Exemplary Embodiment

Generally, in magnetic field coupling type transmitting and receiving elements, when a transmitting element is apart from a receiving element, even if the gap is about several millimeters, the magnetic flux emitted from one end diffuses and the amount of magnetic flux that does not reach the receiving element increases. Further, if the housing is made of metal, eddy currents generated when magnetic flux enters the housing also cause weakened bonding strength between the transmitting and receiving elements, provided by the magnetic field. Eddy currents are electric currents that flow on a metal surface to generate magnetic flux in a direction that cancels out the entering magnetic flux. For this reason, higher power needs to be supplied to the transmitting and receiving element at the transmitting side.

If housing 15 is made of non-magnetic metal such as aluminum, because the relative magnetic permeability of aluminum is almost “1,” there is no significant change in magnetic permeability between the inside and the outside of the portions in which non-magnetic substances 17 such as resin are embedded, as illustrated in FIG. 4. For this reason, magnetic flux emitted from the ends of transmitting and receiving elements 3a and 4a is not concentrated by the non-magnetic substance and tends to diffuse. Therefore, if the magnetic flux emitted from one end of one transmitting and receiving element can be concentrated and guided to the other transmitting and receiving element, transmission efficiency can be improved.

Thus, in a third exemplary embodiment, as illustrated in FIG. 5, ferromagnetic substances 18 are embedded in portions in housings 15 between the ends of ferromagnetic substance 16 included in transmitting and receiving element 3a and the ends of ferromagnetic substance 16 included in transmitting and receiving element 4a. FIG. 5 is a schematic diagram illustrating an exemplary configuration of a communication device according to a third exemplary embodiment.

It is generally known that ferromagnetic substance 18 concentrates magnetic flux. Thus, in a configuration as illustrated in FIG. 5, magnetic flux 14a emitted from one end of one transmitting and receiving element is concentrated at ferromagnetic substance 18 installed in housing 15, and reaches the other transmitting and receiving element.

According to the third exemplary embodiment, portions that guide a line of magnetic flux (ferromagnetic substances 18) are provided in housings 15, and thereby the amount of magnetic flux that is not used for signal transmission can be reduced more than in the communication device of the second exemplary embodiment.

Furthermore, like the present exemplary embodiment, portions that guide a line of magnetic flux (ferromagnetic substances 18) are provided in housings 15, and thereby a magnetic circuit similar to closed magnetic circuit structure can be formed by ferromagnetic substances 16 included in transmitting and receiving elements 3a and 4a and ferromagnetic substances 18 included in housings 15. Thus, the amount of magnetic flux entering housing 15 is reduced, so that loss caused by eddy currents flowing on housing 15 (eddy-current loss) can also be reduced. Accordingly, signal transmission efficiency of a communication device can be further improved.

### Fourth Exemplary Embodiment

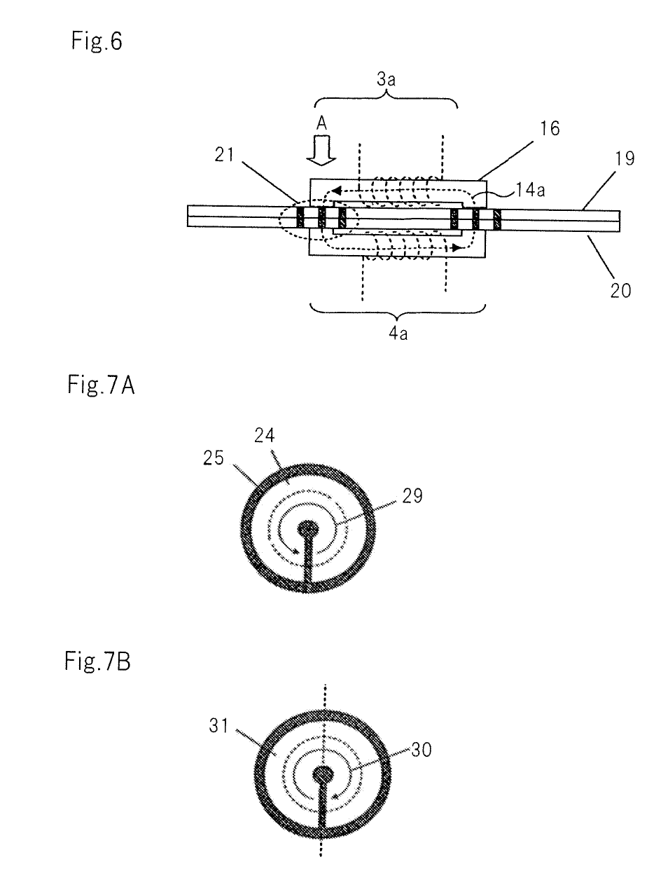

FIG. 6 is a schematic diagram illustrating an exemplary configuration of a communication device according to a fourth exemplary embodiment.

As illustrated in FIG. 6, in the fourth exemplary embodiment, flux concentrators 21 are embedded in portions between ends of ferromagnetic substance 16 of transmitting and receiving element 3a and ends of ferromagnetic substance 16 of transmitting and receiving element 4a.

Flux concentrators 21 converts magnetic flux emitted from one transmitting and receiving element into an eddy current, guides the eddy current to the other transmitting and receiving element of the housings, and forms magnetic flux on a surface of the housing at the side of the other transmitting and receiving element by the guided electric current, thereby providing magnetic field coupling between the two transmitting and receiving elements.

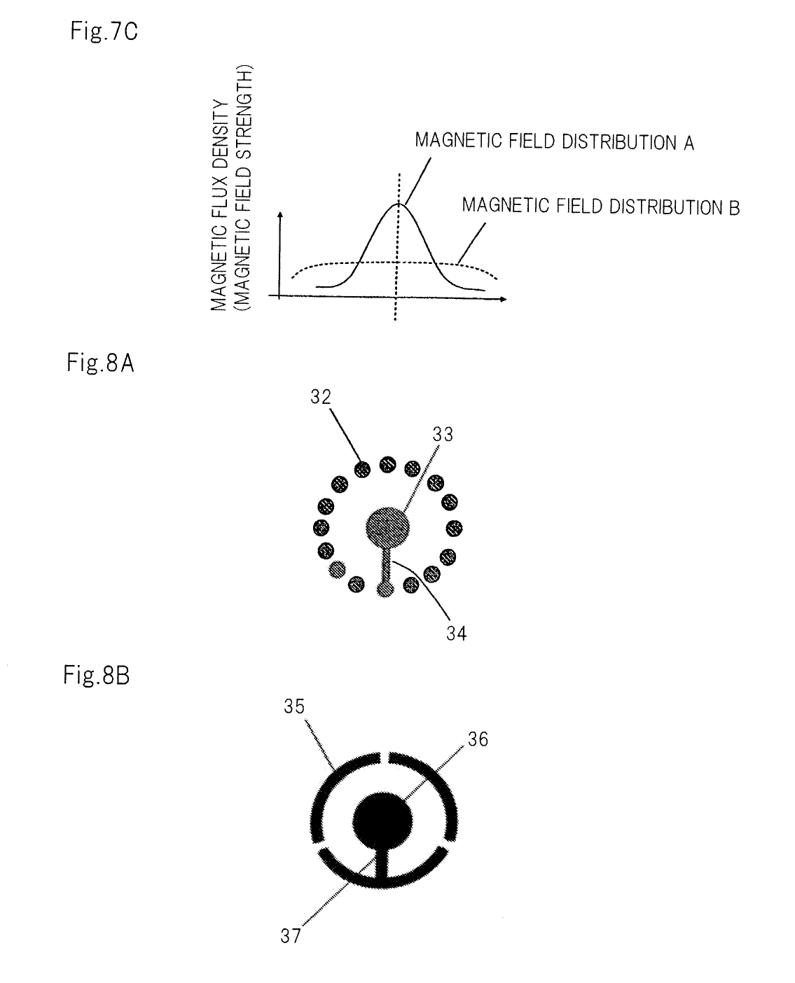

As illustrated in FIG. 7A, flux concentrator 21 is, for example, substantially wide-C-shaped disc 24 and is embedded in each of housings 19 and 20 illustrated in FIG. 6. Flux concentrators 21 are made of metal such as aluminum like housings 19 and 20, and resin 25 is filled in the gap between housings 19 and 20 to ensure waterproofness as well as to fix flux concentrators 21 to housings 19 and 20. FIG. 7A illustrates an enlarged view of flux concentrators 21 illustrated in FIG. 6, as seen from A.

As illustrated in FIG. 6, if housings 19 and 20 are in contact with each other, flux concentrators 21 included in housings 19 and 20 are also in contact with each other to enable electrical conductivity. It should be noted that if flux concentrators 21 fixed to housings 19 and 20 do not conduct electricity, the same effect is provided. Flux concentrators 21 are not limited to discs and may be elliptic or rectangular boards. In the example illustrated in FIG. 7A, since a cross-sectional shape of ferromagnetic substances 16 of transmitting and receiving elements 3a and 4a is circle, substantially C-shaped discs are used as flux concentrators 21. The external shape of flux concentrators 21 may be determined according to the cross-sectional shape of ferromagnetic substances 16 of the transmitting and receiving elements.

In such a configuration, if magnetic flux 14a is generated by one transmitting and receiving element illustrated in FIG. 6, generated magnetic flux 14a enters flux concentrators 21 from one end of ferromagnetic substance 16. At this time, eddy currents 29 flow on a surface of metal flux concentrators 21 along the shape of letter C by electromagnetic induction. Since flux concentrators 21 are wide-C-shaped, the strength and the direction of flowing electric currents vary depending upon the width direction (radial direction). Specifically, electric current density is higher in the inner radius of circumference than in the outer radius. If housings 19 and 20 conduct electricity, because flux concentrators 21 included in housings 19 and 20 form one closed circuit, foregoing eddy currents 29 also reach surface 31 of flux concentrator 21 at the side of the other transmitting and receiving element.

On surface 31 of flux concentrator 21 at the side of the other transmitting and receiving element, as illustrated in FIG. 7B, electric current 30 flows along the shape of letter C and a magnetic field is generated by electric current 30. Since the electric current density is higher in the inner radius of the shape C as described above, the strength of the generated magnetic field is indicated by distribution A in FIG. 7C, having a peak at around the center.

That is, like ferromagnetic substance 18 illustrated in FIG. 5, flux concentrators 21 illustrated in FIG. 7A can concentrate magnetic flux emitted from one end of a ferromagnetic substance of the transmitting and receiving element. The fact that such a substantially C-shaped conductor can concentrate magnetic flux is also described in, for example, Non Patent Literature 1 (Tetsuhiko MAEDA, Sotoshi YAMADA, and Masayoshi IWAHARA, “Eddy current testing probe using flux concentration effect,” Journal of JSAEM, Vol. 9, No. 1, pages 27 to 32, Mar. 10, 2001). According to the present invention, a specific configuration and structure for transmitting and receiving elements for holding communications between walls of metal housings using magnetic flux concentrating elements is provided.

It should be noted that magnetic field distribution A illustrated in FIG. 7C shows a schematic shape of the magnetic field generated by flux concentrators 21, but not the accurate magnetic field strength. If housings 19 and 20 do not have means for concentrating magnetic flux, such as flux concentrators 21, as shown in magnetic field distribution B in FIG. 7C, magnetic flux emitted from the ends of transmitting and receiving elements 3a and 4a diffuse.

FIGS. 8A and 8B are modified examples of flux concentrators 21 illustrated in FIG. 7A.

In the example of FIG. 8A, circular through-holes 32 and 33 and linear through-hole 34 are made in housings 19 and 20, and thereby housings 19 and 20 are provided with the same function as that of magnetic flux concentrators 21 illustrated in FIG. 7A. Resin is filled in each through-hole to ensure waterproofness. In this manner, if flux concentrators 21 are created with a plurality of through-holes, the strength of housings 19 and 20 can be maintained. As well, magnetic flux concentrators 21 can be easily created.

In the example of FIG. 8B, semicircular through-holes 35, circular through-hole 36, and linear through-hole 37 are made on housings 19 and 20, and thereby housings 19 and 20 are provided with the same function as that of magnetic flux concentrators 21 illustrated in FIG. 7A. Resin is filled in each through-hole to ensure waterproofness. In such a configuration, since a C-shaped metal plate is connected with an external metal plate at three positions, the strength of housings 19 and 20 can be maintained. As well, magnetic flux concentrators 21 can be more easily created because the number of through-holes may be small.

According to the fourth exemplary embodiment, magnetic flux concentrators 21 that concentrate magnetic flux are provided in housings 19 and 20, and thereby, as in the third exemplary embodiment, the amount of magnetic flux that is not used for signal transmission can be reduced. Accordingly, signal transmission efficiency of a communication device can be further improved.

### Fifth Exemplary Embodiment

A fifth exemplary embodiment is an exemplary configuration in which housings 38 and 39 between two transmitting and receiving elements 41 and 42 are relatively thick metal plates.

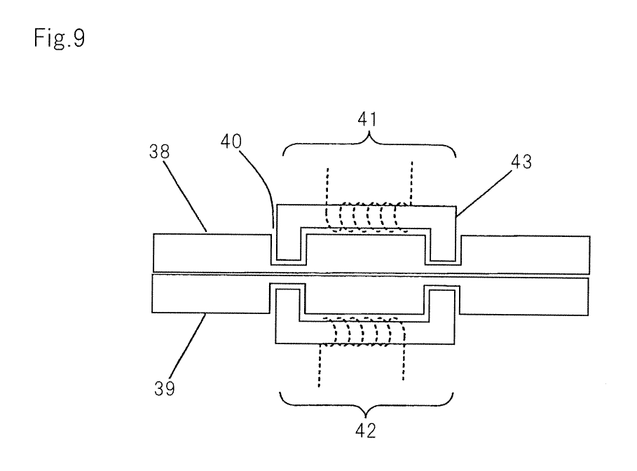

FIG. 9 is a schematic diagram illustrating an exemplary configuration of a communication device according to the fifth exemplary embodiment.

As illustrated in FIG. 9, in the fifth exemplary embodiment, concave portions 40 are made in each of housings 38 and 39, and transmitting and receiving elements 41 and 42 are arranged so that the ends of ferromagnetic substances 43 are positioned in concave portions 40. The configuration of the fifth exemplary embodiment illustrated in FIG. 9 may be combined with the communication devices shown in the second to the fifth exemplary embodiments.

According to the fifth exemplary embodiment, even if housings 38 and 39 are relatively thick metal plates, transmitting and receiving elements 41 and 42 can be arranged with the ends of ferromagnetic substance 43 of element 41 and the ends of substance 43 of element 42 close to each other. Thus, the transmission loss caused if the magnetic flux that is emitted from one transmitting and receiving element does not reach the other transmitting and receiving element can be reduced.

It should be noted that the first to the fifth exemplary embodiments described hereinbefore have shown examples in which transmitting and receiving elements 3 and 4 are used for signal transmission, but transmitting and receiving elements 3 and 4 may also be used as proximity sensors.

Transmitting and receiving elements 3 and 4 shown in the first to the fifth exemplary embodiments can normally transmit and receive signals when elements 3 and 4 are close to each other. For example, if power supply module housing 1 illustrated in FIG. 1 is replaced, it is necessary to check whether or not new power supply module housing 1 is correctly coupled to amplifying module housing 2. Because large power is supplied to traveling-wave tube 6 included in amplifying module housing 2, if the two housings are incompletely coupled to each other, a failure may be caused.

Thus, if signal transmission between power supply control module 8 and RF control module 5 is established by using transmitting and receiving elements 3 and 4, it can be confirmed that power supply module housing 1 and amplifying module housing 2 are installed in place. Accordingly, power supply control module 8 can determine whether or not power supply to traveling-wave tube 6 is ready.

While the invention has been particularly shown and described with reference to exemplary embodiments thereof, the invention is not limited to these exemplary embodiments. It will be understood by those ordinarily skilled in the art that various changes in form and details may be made therein without departing from the spirit and scope of the present invention as defined by the claims.

1. A communication device comprising:
a first transmitting and receiving element that generates and detects a magnetic field; and
a second transmitting and receiving element that detects a magnetic field generated by said first transmitting and receiving element and generates a magnetic field detectable by said first transmitting and receiving element,
wherein said first and second transmitting and receiving elements transmit and receive a signal through magnetic field coupling between ends of said first and second transmitting and receiving elements.

2. The communication device according to claim 1, wherein
each of said first and second transmitting and receiving elements comprises:
a solenoid coil; and
a U-shaped ferromagnetic substance wound with the solenoid coil, and
ends of the ferromagnetic substance included in said first transmitting and receiving element and in said second transmitting and receiving element are arranged so as to face each other.

3. The communication device according to claim 1, further comprising
a flux concentrator that concentrates magnetic flux, between the ends of the ferromagnetic substance included in said first transmitting and receiving element and in said second transmitting and receiving element.

4. The communication device according to claim 3, wherein
said flux concentrator is a disc made of C-shaped metal.

5. An electronic equipment comprising:
a first module including a first transmitting and receiving element according to claim 1, said first transmitting and receiving element being installed in an inner wall of a housing made of a metal plate; and
a second module including a second transmitting and receiving element according to claim 1, said second transmitting and receiving element being installed in an inner wall of a housing made of a metal plate so as to face said first transmitting and receiving element.
